(19) United States
(12) Patent Application Publication
(10) Pub. No.: US 2023/0120279 A1
(43) Pub. Date: Apr. 20, 2023

(54) CLAMPING BLADE ANCHOR

(71) Applicant: International Patent Development Group, LLC, Reno, NY (US)

(72) Inventor: Gregory A. M. Brown, Reno, NV (US)

(21) Appl. No.: 17/502,970

(22) Filed: Oct. 15, 2021

(51) Int. Cl. F16B 13/12

(52) U.S. Cl. CPC F16B 13/122

(57) ABSTRACT

Clamping anchors, kits, and related methods. The present anchors comprise a body with proximal base and distal blade configured to rotate relative to the base. The base defines a channel through which a screw or pin is advanced to apply force to a moment arm projection to rotate the blade and can also include a secondary moment arm offset longitudinally from the transverse line toward the distal end of blade. The moment arm(s) can be straight, curved, or angled surfaces that apply sufficient bending moment to rotate the blade up to 90 degrees or more relative to longitudinal axis. Kits comprise one or more anchors and a screw. The methods comprise inserting an anchor through substrate, advancing a screw through the channel so the distal end pushes the moment arm toward the distal end of anchor causing the blade to bend, at the transverse line, away from the longitudinal axis.

### FIELD OF DISCLOSURE

The present disclosure generally relates to clamping anchors, and, more particularly but not by way of limitation, metallic clamping anchors configured to be inserted into and/or through a material or substrate (e.g., wallboard) and having with a pivoting portion to resist withdrawal from the material or substrate.

### BACKGROUND

Various wallboard anchors are known, including for example the plastic hinged wallboard anchor disclosed in U.S. Patent No. 8,011,080.

### SUMMARY

The present disclosure includes various embodiments of (e.g., metallic) clamping anchors, kits, and methods. Some embodiments may be made from plastic or other suitable materials that are injection molded or use other methods to manufacture the anchor. The present clamping anchors can, for example, be cut from a single, planar piece of metal. In general, the present clamping anchors comprise a body with a proximal base section and a distal blade section that is configured to bend or rotate relative to the base section. The base section defines a channel through which a screw and/or pin (e.g., nail) can be advanced to apply a force to a moment arm projection of the blade section to bend or rotate the blade section. The moment arm can be straight, or curved, or angled to define a concave cam surface configured to maintain sufficient bending moment to bend or rotate the blade section up to 90 degrees or more relative to the longitudinal axis of the screw or pin.

Some embodiments of the present clamping anchors comprise a body having a proximal end, a distal end, upper and lower sides extending from the proximal end to the distal end, and first and second edges extending from the distal end to the proximal end. The body also includes a blade section extending from the distal end toward the proximal end, a base section extending from the blade section toward the proximal end, and an enlarged head at the proximal end. The blade section has a width extending laterally between and to the left and right edges of the body along at least a majority of a length of the blade section, the width of the blade section increases with distance from the distal end, and the blade section comprises a moment arm projection on the lower side. The base section defines a channel that is configured to receive a screw or pin along a longitudinal axis that is parallel to a plane of the blade section and offset from the blade section on the lower side such that the longitudinal axis extends through the moment arm projection; and the blade section is coupled to the base section along a transverse line that is substantially perpendicular to the longitudinal axis such that advancing a screw or pin through the screw channel and into the moment arm projection will cause the blade section to bend or rotate upward about the transverse line.

In some embodiments of the present anchors, a proximal surface of the moment arm projection is offset longitudinally from the transverse line toward the distal end of the blade section.

In some embodiments of the present anchors, the blade section further comprises one or more pilot projections extending from a planar portion of the blade section on the lower side by a height that increases with distance from the distal end. In some such embodiments, the one or more pilot projections comprises a plurality of pilot projections, and at least one of the pilot projections is configured to resist deflection of the moment arm projection toward the distal end. In some such embodiments, the at least one of the pilot projections contacts the moment arm projection and is configured to direct a force received at the moment arm projection to the blade section to urge the blade section upward as the blade bends or rotates. In some such embodiments, the pilot projection configured to resist deflection of the moment arm projection has a lower end that is configured to contact the moment arm projection at a vertical point through which the longitudinal axis passes. In some embodiments, the plurality of pilot projections are spaced along a length of the blade section, each of the pilot projections has a vertical dimension, and the vertical dimensions of the pilot projections increase with distance from the distal end.

In some embodiments of the present anchors, the moment arm projection is longitudinally curved or bent to define a concave cam surface that faces the proximal end. In some such embodiments, the moment arm projection is configured such that, as the blade section rotates upward, a distal end of the screw or pin contacts the moment arm projection at a contact point, and the distance between the contact point and the transverse line increases as the screw or pin advances. In some such embodiments, a first portion of the cam surface intersected by the longitudinal axis is disposed at an angle of between 5 and 90 degrees relative to the longitudinal axis. In some such embodiments, a second portion of the cam surface is disposed at an angle of between 90 degrees and 120 degrees relative to the longitudinal axis. In some such embodiments, the moment arm projection is configured such that, as the blade section rotates upward, the contact point moves from the first portion of the cam surface to the second portion of the cam surface. In some such embodiments, a third portion of the cam surface is disposed at an angle of between 120 and 145 degrees relative to the longitudinal axis. In some such embodiments, the moment arm projection is configured such that, as the blade section rotates upward, the contact point moves from the second portion of the cam surface to the third portion of the cam surface. In some such embodiments, a fourth portion of the cam surface is disposed at an angle of from 145 to 180 degrees relative to the longitudinal axis. In some such embodiments, the moment arm projection is configured such that, as the blade section rotates upward, the contact point moves from the third portion of the cam surface to the fourth portion of the cam surface. In some such embodiments, a lower end of the moment arm extends longitudinally under the base section.

In some embodiments of the present anchors, the moment arm is laterally curved or bent to define a screw path extending along at least a portion of a length of the moment arm to center a screw received through the screw channel to contact the moment arm.

In some embodiments of the present anchors, the blade section has a first thickness measured in a vertical direction that is substantially perpendicular to each of the longitudinal axis and the transverse line, and the body has a second thickness along that transverse line, the second thickness measured in the vertical direction and being less than the first thickness.

In some embodiments of the present anchors, the body is configured such that driving a screw or pin through the channel and into the moment arm will push a portion of the moment arm toward the distal end and cause the blade section to bend or rotate, at the transverse line, away from the longitudinal axis. In some such embodiments, the blade section is configured to bend to an angle of from 5 degrees to 110 degrees relative to the longitudinal axis.

In some embodiments of the present anchors, the body is defined by a single piece of sheet metal. In some such embodiments, the base section is defined by a first portion of the piece of sheet metal, and a second portion of the piece of sheet metal, where the second portion of the piece of sheet metal is bent along the first edge relative to the first portion of the piece of sheet metal, and the second portion of the piece of sheet metal is coupled adjacent the second edge to the first portion of the piece of sheet metal, such that the second portion of the piece of sheet metal defines the lower side of the base section, the first portion of the piece of sheet metal defines the upper side of the base section, and the channel is defined between the first and second portions of the piece of sheet metal. In some such embodiments, the second portion of the piece of sheet metal is bent around a lateral edge of the first portion of the piece of sheet metal along the second edge of the body to resist separation of the second portion of the piece of sheet metal from the first portion of the piece of sheet metal along the second edge.

In some embodiments in which the body is defined by a single piece of sheet metal, the first portion of the piece of sheet metal includes a first non-planar portion that bends outward relative to the second portion of the piece of sheet metal, and the second portion of the piece of sheet metal includes a second non-planar portion that bends outward relative to the first portion of the piece of sheet metal, such that the first and second non-planar portions cooperate to define the channel.

In some embodiments in which the body is defined by a single piece of sheet metal, the first portion of the piece of sheet metal includes at least one first opening configured to receive a portion of a thread of a screw driven into the channel.

In some embodiments in which the body is defined by a single piece of sheet metal, the second portion of the piece of sheet metal includes at least one second opening configured to receive a portion of a thread of a screw driven into the channel. In some such embodiments, the second portion of the piece of sheet metal includes one or more projections extending into the channel and shaped to engage a portion of a thread of a screw driven into the channel.

In some embodiments in which the body is defined by a single piece of sheet metal, the blade section is defined by a third portion of the piece of sheet metal that includes a substantially planar blade region, and the first portion of the piece of sheet metal includes a substantially planar base region that is coplanar with the substantially planar blade region.

In some embodiments in which the body is defined by a single piece of sheet metal, the enlarged head is defined by fourth and fifth portions of the piece of sheet metal that are substantially perpendicular to the longitudinal axis, where the fourth portion of the piece of sheet metal extends from the first portion of the piece of sheet metal, and the fifth portion of the piece of sheet metal extends from the second portion of the piece of sheet metal. In some such embodiments, a distal surface of the enlarged head includes indicia indicating the direction of the upper side and/or the direction of the lower side.

In some embodiments of the present anchors, a distance between the transverse line and a distal surface of the enlarged head is between 0.2 inches and 0.8 inches. In some such embodiments, a distance between the transverse line and a distal surface of the enlarged head is between 0.2 inches and 0.3 inches (corresponding to nominal ¼″ drywall or paneling), between 0.35 inches and 0.4 inches (corresponding to nominal ⅜″ drywall or paneling), between 0.4 inches and 0.6 inches (corresponding to nominal ½″ drywall or paneling), between the transverse line and a distal surface of the enlarged head is between 0.6 inches and 0.65 inches (corresponding to nominal ⅝″ drywall or paneling), or between 0.7 and 0.8 inches (corresponding to nominal ¾″ drywall or paneling). In other embodiments, these dimensions are doubled for fire-rated walls in which two adjacent layers of drywall are used.

Some embodiments of the present kits comprise: one or more of the present anchors; and a screw for each of the one or more anchors, where each screw is configured to be driven into the channel of a respective one of the anchors such that a distal end of the screw pushes the moment arm toward the distal end of the anchor body and causes the blade section to bend, at the transverse line, away from the longitudinal axis to an angle of from 5 degrees to 110 degrees relative to the longitudinal channel. In some such embodiments, the one or more anchors comprises a plurality of anchors. In some such embodiments, at least one of the plurality of anchors differs in size relative to at least one other one of the plurality of anchors. In some such embodiments, the anchors of differing size have channels with different transverse dimensions to accommodate screws or pins/nails of different sizes. In some such embodiments, the anchors of differing sizes have base sections of different lengths.

Some embodiments of the present methods comprise: inserting one of the present anchors through a substrate; and driving a screw or pin through the channel such that a distal end of the screw or pin pushes the moment arm toward the distal end of the anchor body and causes the blade section to bend, at the transverse line, away from the longitudinal axis. In some such embodiments, the substrate or wallboard comprises drywall. In some such embodiments, the anchor is inserted through the substrate or wallboard without first drilling a pilot hole in the substrate or wallboard. In some such embodiments, the screw or pin is driven through the channel to a point at which the blade section is bent away from the longitudinal axis at an angle of from 5 degrees to 110 degrees relative to the longitudinal axis. In some such embodiments, the screw or pin is driven through the channel to a point at which the blade section is bent away from the longitudinal axis at an angle of at least 75 degrees relative to the longitudinal axis.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any embodiment of the present apparatuses, kits, and methods, the term “substantially” may be substituted with “within [a percentage] of” what is specified, where the percentage includes 0.1, 1, 5, and/or 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus or kit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, an apparatus, device or system that is configured in a certain way is configured in at least that way, but it can also be configured in other ways than those specifically described.

Any embodiment of any of the present apparatuses and methods can consist of or consist essentially of – rather than comprise/include/contain/have – any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

Some details associated with the aspects of the present disclosure are described above, and others are described below. Other implementations, advantages, and features of the present disclosure will become apparent after review of the entire application, including the Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical labels or reference numbers do not necessarily indicate an identical structure. Rather, the same reference number may be used to indicate a similar feature or a feature with similar functionality, as may non-identical reference numbers. Dimensioned figures are drawn to scale (unless otherwise noted), meaning the sizes of the depicted elements are accurate relative to each other for at least the embodiment depicted in the figures.

FIG. 1 is a distal end view of a first embodiment of the present clamping anchors.

FIG. 2 is a proximal end view of the anchor of FIG. 1.

FIG. 3 is a top plan view of the anchor of FIG. 1.

FIG. 4 is a bottom plan view of the anchor of FIG. 1.

FIG. 5 is a right side view of the anchor of FIG. 1.

FIG. 5A is an enlarged right side view of a portion of the anchor of FIG. 1.

FIG. 6 is a left side view of the anchor of FIG. 1.

FIGS. 7 and 8 are perspective views of the anchor of FIG. 1.

FIG. 9 is a bottom plan view of an unfolded blank for forming the anchor of FIG. 1.

FIG. 10 is a cross-sectional view of the anchor of FIG. 1 taken along the line 10-10 of FIG. 6.

FIGS. 11-14 are right side cross-sectional views of the anchor of FIG. 1 extending through a wallboard, showing sequential stages in the deployment of the anchor.

FIG. 15 is a distal end view of a second embodiment of the present clamping anchors.

FIG. 16 is a proximal end view of the anchor of FIG. 15.

FIG. 17 is a top plan view of the anchor of FIG. 15.

FIG. 18 is a bottom plan view of the anchor of FIG. 15.

FIG. 19 is a right side view of the anchor of FIG. 15.

FIG. 20 is a left side view of the anchor of FIG. 15.

FIGS. 21 and 22 are perspective views of the anchor of FIG. 15.

FIG. 23 is a bottom plan view of an unfolded blank for forming the anchor of FIG. 15.

FIG. 24 is a cross-sectional view of the anchor of FIG. 15 taken along the line 24-24 of FIG. 20.

FIGS. 25-28 are right side cross-sectional views of the anchor of FIG. 15 extending through a wallboard, showing sequential stages in the deployment of the anchor.

FIG. 29 is a distal end view of a third embodiment of the present clamping anchors.

FIG. 30 is a proximal end view of the anchor of FIG. 29.

FIG. 31 is a top plan view of the anchor of FIG. 29.

FIG. 32 is a bottom plan view of the anchor of FIG. 29.

FIG. 33 is a right side view of the anchor of FIG. 29.

FIG. 34 is a left side view of the anchor of FIG. 29.

FIGS. 35 and 36 are perspective views of the anchor of FIG. 29.

FIG. 37 is a bottom plan view of an unfolded blank for forming the anchor of FIG. 29.

FIG. 38 is a cross-sectional view of the anchor of FIG. 29 taken along the line 38-38 of FIG. 34.

FIGS. 39-42 are right side cross-sectional views of the anchor of FIG. 29 extending through a wallboard, showing sequential stages in the deployment of the anchor.

FIG. 43 is a distal end view of a fourth embodiment of the present clamping anchors.

FIG. 44 is a proximal end view of the anchor of FIG. 43.

FIG. 45 is a top plan view of the anchor of FIG. 43.

FIG. 46 is a bottom plan view of the anchor of FIG. 43.

FIG. 47 is a right side view of the anchor of FIG. 43.

FIG. 48 is a left side view of the anchor of FIG. 43.

FIGS. 49 and 50 are perspective views of the anchor of FIG. 43.

FIG. 51 is a bottom plan view of an unfolded blank for forming the anchor of FIG. 43.

FIG. 52 is a cross-sectional view of the anchor of FIG. 43 taken along the line 52-52 of FIG. 48.

FIGS. 53-56 are right side cross-sectional views of the anchor of FIG. 29 extending through a wallboard, showing sequential stages in the deployment of the anchor.

FIG. 57 is a distal end view of a fifth embodiment of the present clamping anchors.

FIG. 58 is a proximal end view of the anchor of FIG. 57.

FIG. 59 is a top plan view of the anchor of FIG. 57.

FIG. 60 is a bottom plan view of the anchor of FIG. 57.

FIG. 61 is a right side view of the anchor of FIG. 57.

FIG. 62 is a left side view of the anchor of FIG. 57.

FIGS. 63 and 64 are perspective views of the anchor of FIG. 57.

FIGS. 65-68 are right side cross-sectional views of the anchor of FIG. 57 extending through a wallboard, showing sequential stages in the deployment of the anchor.

FIG. 69 is a distal end view of a sixth embodiment of the present clamping anchors.

FIG. 70 is a proximal end view of the anchor of FIG. 69.

FIG. 71 is a top plan view of the anchor of FIG. 69.

FIG. 72 is a bottom plan view of the anchor of FIG. 69.

FIG. 73 is a right side view of the anchor of FIG. 69.

FIG. 74 is a left side view of the anchor of FIG. 69.

FIGS. 75 and 76 are perspective views of the anchor of FIG. 69.

FIG. 77 is a bottom plan view of an unfolded blank for forming the anchor of FIG. 69.

### DETAILED DESCRIPTION OF ILLUSTRATIVE EMBODIMENTS

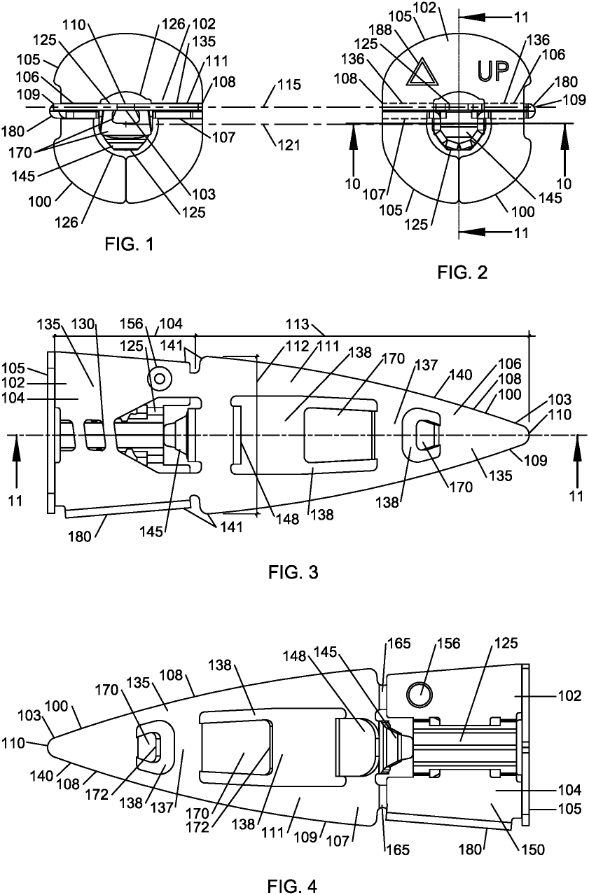

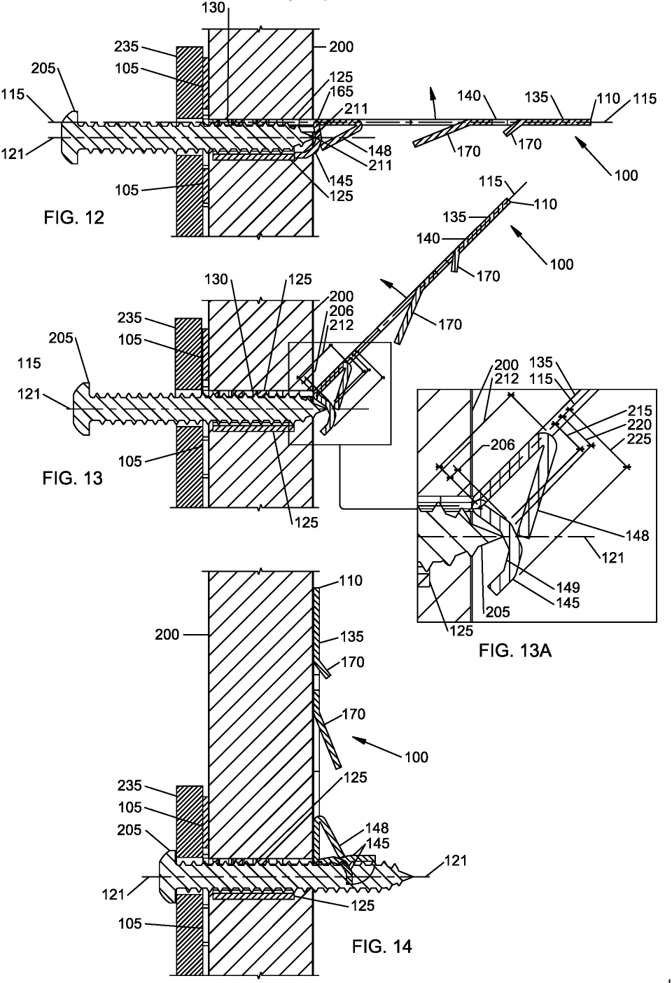

Referring now to the drawings, and more particularly to FIGS. 1-14, shown there and designated by the reference numeral 100 is a first embodiment of the present clamping anchors. As shown, anchor 100 comprises a body having a proximal end 102, a distal end 103, upper and lower sides 106, 107 extending from the proximal end 102 to the distal end 103, and first and second edges 108, 109 extending from the proximal end to the distal end. As also shown, the body includes a blade section 111 extending from distal end 103 toward proximal end 102, a base section 104 extending from blade section 111 toward proximal end 102, and an enlarged head 105 at proximal end 102. Blade section 111 has a width 112 extending laterally between and to the left and right edges 108, 109 of the body along at least a majority of a length 113 of the blade section, and the width of the blade section increases with distance (toward proximal end 102) from distal end 103. The body also includes a lever or moment arm 145 projecting from blade section 111 on lower side 107. In this embodiment, base section 104 defines a flat or substantially planar bearing surface 150 to distribute shear loads for the anchor onto the substrate with a screw channel 125 that is configured to receive a screw 205 (see, e.g., FIGS. 12-14) along a longitudinal axis 121 that is parallel to a plane 115 of the blade section and offset a distance 210 from the blade section on the lower side such that the longitudinal axis (121) of the screw channel extends through moment arm 145. As shown, blade section 111 is coupled to base section 104 along a transverse line (through hinge sections 165) that is substantially perpendicular to longitudinal axis 121 and parallel to the plane (through axis 115) of the blade section.

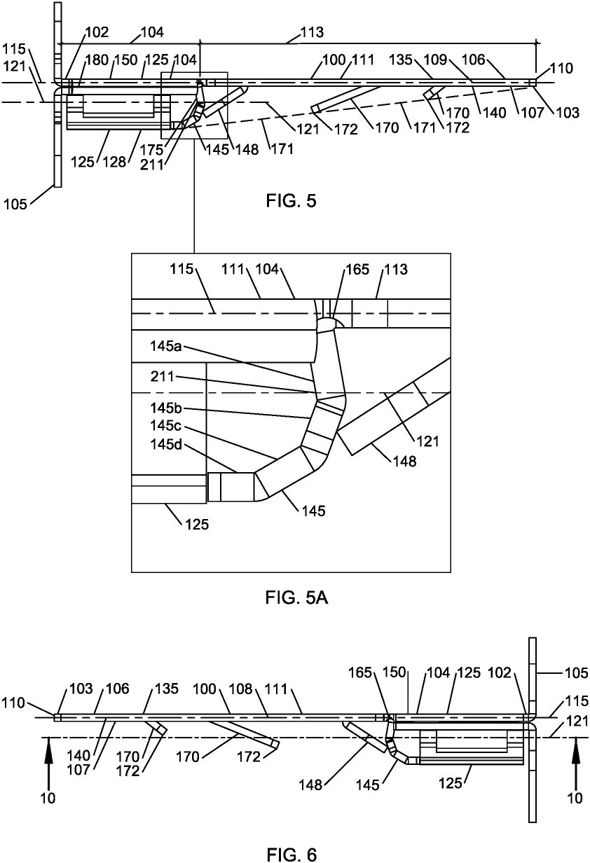

Blade section 111 further comprises one or more pilot projections 148, 170 extending from a planar portion of the blade section on the lower side 107 by a height that increases with distance from the distal end 103, for example as indicated by line 171 in FIG. 5. For example, in the first embodiment of FIGS. 1-14, a first projection 170 closest to distal end 103 extends a first distance on lower side 107 measured perpendicular to plane 115 of the blade section, a second projection that is next-farthest from distal end 103 extends a second, greater distance on lower side 107 measured perpendicular to plane 115, and a third projection 148 that is farthest from distal end 103 extends a third, yet-greater distance on lower side 107 measured perpendicular to plane 115. In this embodiment, projection 148 has a lower end that is configured to contact moment arm 145 to resist deflection of the moment arm toward distal end 103. In this embodiment, a single opening 138 is cut or punched out of material to define both of the second projection 170 and the third projection 148. To that end, projections 170 and 148 do not extend downward beyond the lower surface of the base portion (104) that defines the screw channel (125), such that the projections 170, 148 do not push out more of the material or substrate into which the anchor is inserted than is needed to allow the screw channel to extend through the substrate. In this embodiment, a lower end of moment arm 145 extends longitudinally under base section 104—i.e., proximal of hinge sections 165—and, to enable lower arm to extend proximally of hinge sections 165, the distal end of the portion of base section 104 that defines the screw channel (125) is spaced proximally of hinge sections 165.

In the embodiment of FIGS. 1-14, moment arm 145 extends a fourth, greatest distance on lower side 107 measured perpendicular to plane 115, such that line 171 follows a linear slope from distal end 103 to the lowermost points of first and second projections 170, and the lowermost point of moment arm 145. In use, anchor 100 can be pressed or hammered through substrate (e.g. dry wall) and the gradually increasing height of blade section 111 progressively and gradually increases the size of the hole created by the anchor and thereby reduces the likelihood of “blowout″—i.e., portions of the distal side of the drywall breaking away to create a larger hole than is needed to allow the anchor to be seated therethrough.

As shown in FIG. 9, anchor 100 can be formed from a single piece of sheet metal, for example by creating opening 138 to define the portions of the sheet metal that are subsequently bent to form the three-dimensional shape of anchor 100. The cuts on the metal to create the openings (138) can be sheared, punched, stamped, cut by laser or water jet, or any other suitable means to separate the materials to define the shape and forms. For example, in this embodiment base section 104 is defined by a first portion 176 of the piece of sheet metal, and a second portion 178 of the piece of sheet metal, where the second portion of the piece of sheet metal is bent or folded 180 along right edge 109 relative to the first portion of the piece of sheet metal, and second portion 178 of the piece of sheet metal is coupled adjacent left edge 108 to first portion 176 of the piece of sheet metal, such that second portion 178 of the piece of sheet metal defines lower side 107 of the base section, first portion 176 of the piece of sheet metal defines upper side 106 of the base section, and channel 125 is defined between the first and second portions 176, 178 of the piece of sheet metal. In the depicted first embodiment, second portion 178 is coupled to first portion 176 adjacent left edge 108 by a weld 156 (or rivet, swag, fastener, dimple, punch, or the like). As shown, second portion 178 of the piece of sheet metal includes a first non-planar portion 128 that bends outward relative to first portion 176 of the piece of sheet metal. In this embodiment, second portion 178 includes two openings 138 cut or punched out of the first portion to define the non-planar portion 128, and two notched projections 131 that extend into the screw channel 125 to be engaged by threads of a screw. In this embodiment, first portion 176 of the piece of sheet metal also includes a plurality of elongated openings 130 extending through the sheet metal and angled to be engaged by threads of a screw within the screw channel (125).

As also shown in FIG. 9, blade section 111 is defined by a third portion 182 of the piece of sheet metal that includes a substantially planar blade region that is substantially coplanar with the first portion 176 of the piece of sheet metal includes a substantially planar base region that is coplanar with the substantially planar blade region of the third portion 182. In this embodiment, hinge sections 165 are disposed along a transverse line (parallel to plane 115) between first portion 176 (base section 104) and third portion 182 (blade section 111). In this embodiment, the piece of sheet metal has a first thickness perpendicular to plane 115 (measured in a vertical direction of FIGS. 5-6) that is equal to the nominal thickness of the sheet metal, and the anchor 100 has a second, smaller thickness along that transverse line (and hinge sections 165) such that the blade section will bend relative to the base section along the hinge sections 165 when force is applied as described below. As indicated by points 141, blade section 111 at its proximal end has a width (in plane 115) that is wider than a distal end of base portion 104. In other embodiments, the proximal end of the blade section can have a width that is the same as or smaller than the width of the distal end of the base section.

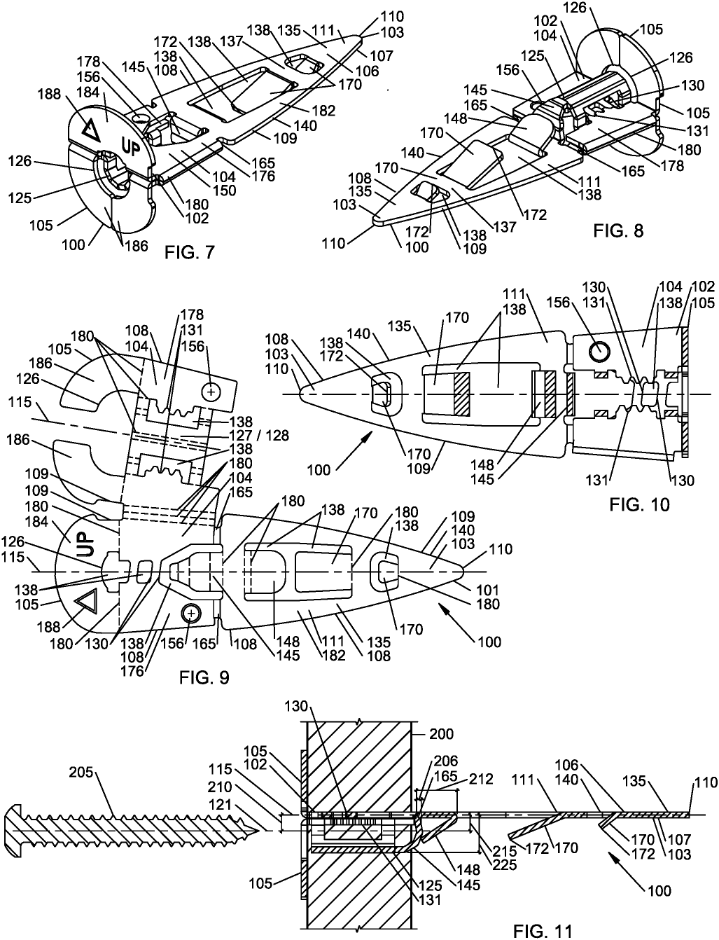

In this embodiment, enlarged head 105 is defined by a fourth portion 184 of the piece of sheet metal that extends from the first portion 176, and a fifth portion 186 of the piece of sheet metal that extends from the second portion 178. More particularly, fourth and fifth portions 184, 186 are folded to be substantially perpendicular to plane 115 and axis 121. As shown in FIG. 7, for example, this embodiment includes indicia 188 on a distal surface of the enlarged head to indicate the direction that the blade portion 111 will rotate when activated by the screw 205 to clamp to the substrate, and/or indicate the upper side and/or the direction of the lower side.

As shown in FIGS. 11-14, anchor 100 is configured to be pressed or driven (e.g., with a hammer) through a piece of substrate (e.g., drywall in these embodiments) 200 such that the anchor extends through the substrate with a distal surface of head 105 at or against a proximal surface of the substrate (e.g., FIG. 11), after which a screw 205 or other fastener (e.g., a nail or pin, or other activation device) can be driven through screw channel 125 of the anchor until the distal end of the screw contacts moment arm 145 (e.g., FIG. 12). The screw can then be further driven through screw channel 125 to cause the distal end of the screw to engage the moment arm 145 at initial contact point 211 which is sloped toward the distal end of the anchor causing the screw 205 to drive the moment arm (145) in a distal direction to cause the linear direction of the screw 205 to apply torque to moment arm 145 and cause blade section 111 to rotate upward around hinge sections 165 relative to base section 104 (e.g., FIG. 13), up to and including a point at which the blade section (111) is bent or angled by 90 degrees or more and an upper surface of the blade section is at or against a distal surface of substrate 200 (e.g., FIG. 14). As shown in FIGS. 11-14, the present anchors can be used to secure a fixture (e.g., a shelf bracket, hanger, or other fixture) to the substrate.

In various embodiments, blade section 111 can be configured to bend to an angle of from 5 degrees to 110 degrees relative to axis 121. For example, in the embodiment shown, hinge sections 165 are a distance from distal side of enlarged head 105 that is substantially equal to or only slightly larger than the thickness of substrate 200 such that blade section 111 bends to an angle of substantially 90 degrees or more when fully deployed, as shown in FIG. 14. If anchor 100 is not installed through a substrate 200 with a thickness roughly equal to the distance between distal side of head 105 and hinge sections 165, then the blade section 111 will be allowed to rotate to an angle of greater than 90 degrees (measured on a distal side of the blade section, relative to axis 121). When the anchor is inserted through a substrate having such a thickness, rotation is effectively limited to 90 degrees by the substrate 200 and the resultant force applied to the distal side of the substrate by the blade section 111 creates a clamping force on substrate 200 between the distal side of the head 105 and the blade section 111, which is forced against the distal side of the substrate by advancing the screw (205) against the moment arm (145). In further embodiments, the distance between hinge sections 165 and distal surface of head 105 is sufficiently smaller than the thickness of substrate 200 for blade section 111 to bend to an angle of from 5 degrees to 89 degrees relative to axis 121. For any of these options, the present anchors can be sized to fit any of various known thicknesses of substrates including by example, wallboard, such as, for example, ¼ inch, ⅜ inch, , ½ inch, ⅝ inch, and/or ¾ inch. For example, in some embodiments, the distance between hinge section 165 (the transverse line between first portion 176 and third portion 178 of the sheet metal) and a distal surface of enlarged head 105 is from 0.2 inches to 0.75 inches (e.g., from 0.2 inches to 0.3 inches, from 0.35 inches to 0.4 inches, from 0.4 inches to 0.6 inches, and/or from 0.6 inches to 0.65 inches. In other embodiments, these dimensions are doubled for fire-rated walls in which two adjacent layers of drywall are used.

As shown in more detail in the enlarged inset of FIG. 13A, moment arm 145 in this embodiment is curved along its length (is longitudinally curved) to define a concave cam surface 149 that faces proximal end 102 of the anchor (and of base section 104). Stated another way, the concave cam surface 149 faces proximal end 102 of the anchor. In this embodiment, concave cam surface 149 is a spline or complex curve that includes multiple linear, arc, or curved segments, some of which are arcuate and of different radii. As can be seen in FIG. 13A, at the upper end or base of moment arm 145 nearest plane 115, cam surface has a segment that is linear or arcuate with a first radius. This base segment of moment arm 145 closest to blade section 111 is straight, angled, curved or sloped toward the distal end 103 of the anchor to allow screw 205 to initiate the torque required to immediately start the rotation of blade section 111 up and away from the linear track of screw 205. This greatly reduces the stresses on the cam or moment arm 145 and blade section 111. Cam surface 149 also includes a plurality or arcuate sections with radii that get progressively smaller as distance from plane 115 increases along cam surface 149. In some embodiments, cam surface 149 also includes at or near its lowermost end, an end segment that is either linear or arcuate with a larger radius than more-medial segments of the moment arm (145). Alternatively, lever or moment arm 145 can be bent such that cam surface 149 includes a plurality of linear segments that approximate a complex curve or spline to achieve the depicted bending of blade section 111 relative to base section 104 when the anchor is deployed (as shown in FIGS. 12-14).

Moment arm projection 145 utilizes the offset between plane 115 and axis 121 to allow screw 205 to create a bending moment around hinge portions 165 to bend blade section 111 as shown in FIGS. 13 and 14. And, the concave configuration of cam surface 149 allows the offset that generates that bending moment to vary as the screw is inserted to generate a sufficiently large bending moment along the full sweep of the blade section to fully seat the blade section against a distal side of the substrate (FIG. 14). For example, the offset begins as shown in FIG. 12 as a vertical distance between plane 115 and axis 121. As shown in FIG. 13A, as the distal end of the screw moves further left to right (in the depicted orientation), the offset between hinge sections 165 and the distal end of the screw increases, and axis 121 of the screw is no longer perpendicular to the point along cam surface 149 that is contacted by the distal end of the screw.

By varying the shape of cam surface 149 along the length of moment arm 145, the geometry relative to hinge sections 165 can be managed to ensure a moment arm distance that increases with the insertion of the screw (and decreasing force) required to rotate blade section 111 up to or beyond 90 degrees relative to axis 121 (measured on a distal side of hinge sections 165) to secure the anchor to the substrate. Specifically, moment arm 145 is bent to shape cam surface 149 to allow the moment arm distance from plane 115 to progress from dimension 215 to dimension 220 to dimension 225. In particular, in the example shown in FIGS. 11-14, moment arm 145 includes a first segment 145a (FIGS. 5 and 5A) extending from the blade section 111 to a point beyond central axis 121 of the screw at an angle of less than 90 degrees (e.g., of between 80 and 90 degrees as shown, but between 5 and 90 degrees in other embodiments) relative to plane 115, and a second segment 145b extending from the lower end of first segment 145a at an angle of greater than 90 degrees (e.g., between 90 and 100 as shown, but between 90 and 120 degrees in other embodiments). The distal end of the screw first contacts the moment arm (145) at point 211 on moment arm segment 145a which is angled or curved at less than 90 degrees relative to the distal end (103) of blade section (111) to ensure predictable contact and rotation of the blade section. As will be appreciated by those of ordinary skill in the art, the moment is greatest when the horizontal force of the screw is applied to a cam surface that is perpendicular to the axis (121) of the screw. To that end, second segment 145b being slightly more than 90 degrees relative to plane 115 ensures maximal rotational force through the initial rotation of the blade section 111 relative to the base section 104. In this embodiment, moment arm 145 includes a third segment 145c (FIGS. 5 and 5A) that is bent or angled relative to plane 115 at an angle that is even larger than that of second segment 145b, for example, greater than 120 degrees (e.g., between 130 and 145 degrees as shown, but between 120 and 145 degrees in other embodiments); and moment arm 145 includes a fourth segment 145d that is bent or angled relative to plane 115 an angle that is even larger than that of third segment 145c, for example, greater than 145 degrees (e.g., substantially parallel to plane 115 in the embodiment shown, but between 145 and 180 degrees in other embodiments). These angles or curves are examples; various angles or curves for the segments can provide a similar result. As a result of these segments with sequentially larger angles relative to plane 115, when blade section 111 bends, the distance between blade section 111 and the distal end of the screw gets progressively larger (from 215, to 220, to 225), and the portion of cam surface 149 in contact with the distal end of the screw is nearly perpendicular to axis 121 at the upper end of each segment to maximize the amount of the horizontal force applied by the screw that can be converted to bending of the blade section (111) to ensure sufficient bending or rotation of the blade section (111) relative to the base section (104), and generate a sufficient clamping force of the blade section against the substrate. Stated another way, the contact point between the screw and the cam surface 149 moves farther away from the hinge sections 165 and thereby increases the length of the moment arm, thereby helping to ensure sufficient torque around hinge sections 165 to bend the blade section relative to the base section of the anchor.

In the embodiment shown, the anchor is further configured to generate a secondary moment arm to bend the blade section (111) relative to the base section (104). In particular, projection 148 extends from an upper (in the orientation of FIGS. 11-12) end downward to a lower end that contacts a distal side of moment arm 145. As a result, when the distal end of a screw (e.g., 205) pushes moment arm to the right (in the origination of FIGS. 11-12), moment arm 145 exerts a force to the right against the lower end of projection 148 that is carried to the blade section at the upper end of projection 148. The component of this force that is perpendicular to plane 115 thereby generates the secondary moment (at moment arm distance 212) to urge the blade section to bend relative to the base section along hinge sections 165 (as shown in the progression of FIGS. 12-14). In addition to the secondary bending moment to encourage bending or rotation of the blade section, the application of force at the upper end of projection 148 also tends to resist unintended, out-of-plane deformation of the blade section by urging the blade against a substrate at the upper end of projection 148, and thereby to fully seat and clamp the upper side of blade section 111 against the distal side of substrate 200, as shown in FIG. 14.

In some embodiments, such as the one shown, the moment arm is also laterally curved or bent to define a screw path extending along at least a portion of a length of the moment arm (e.g., along some or all of cam surface 149) to center a screw received through the screw channel to contact the moment arm. Stated another way, cupping or creating a V-shaped cross section along the cam surface 149 can cause the moment arm to resist lateral slippage or deformation of the moment arm that might otherwise cause the distal end of the screw to lose contact with the moment arm.

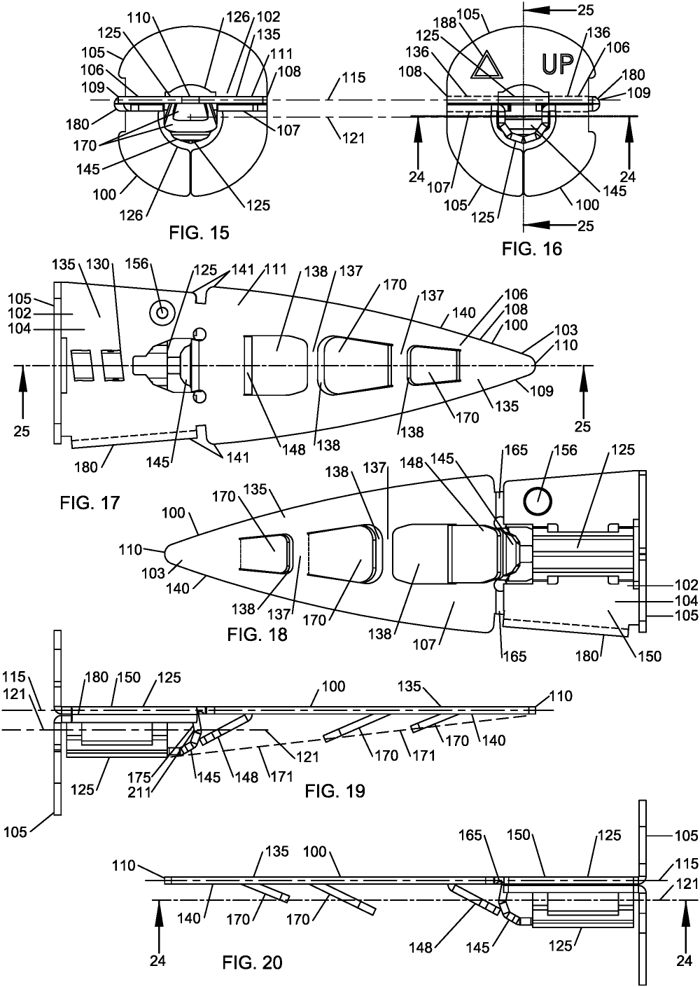

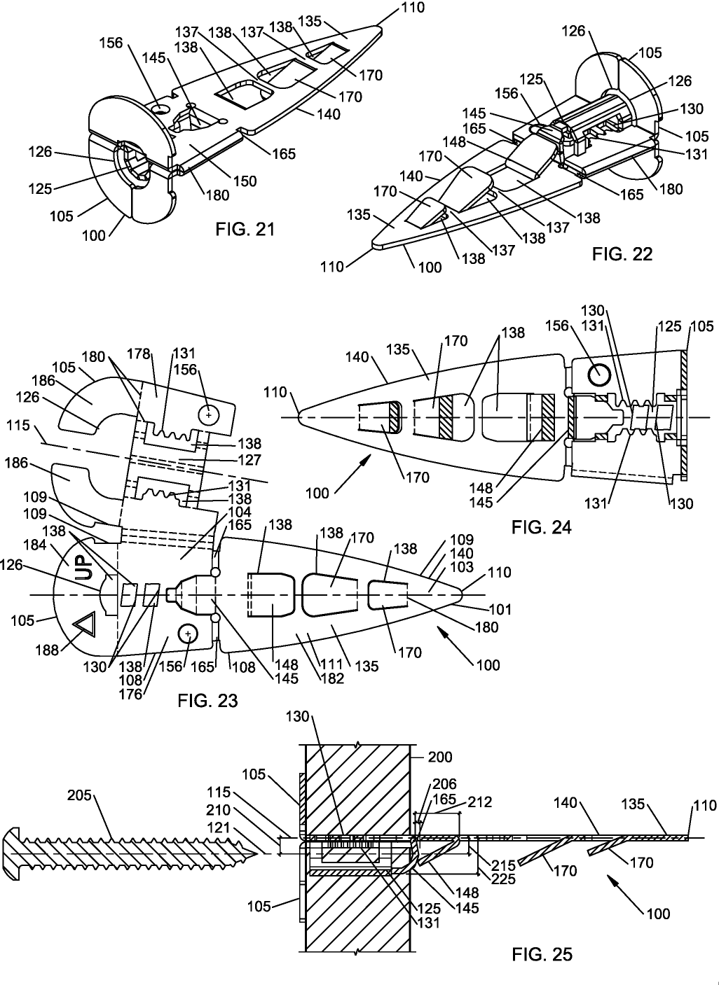

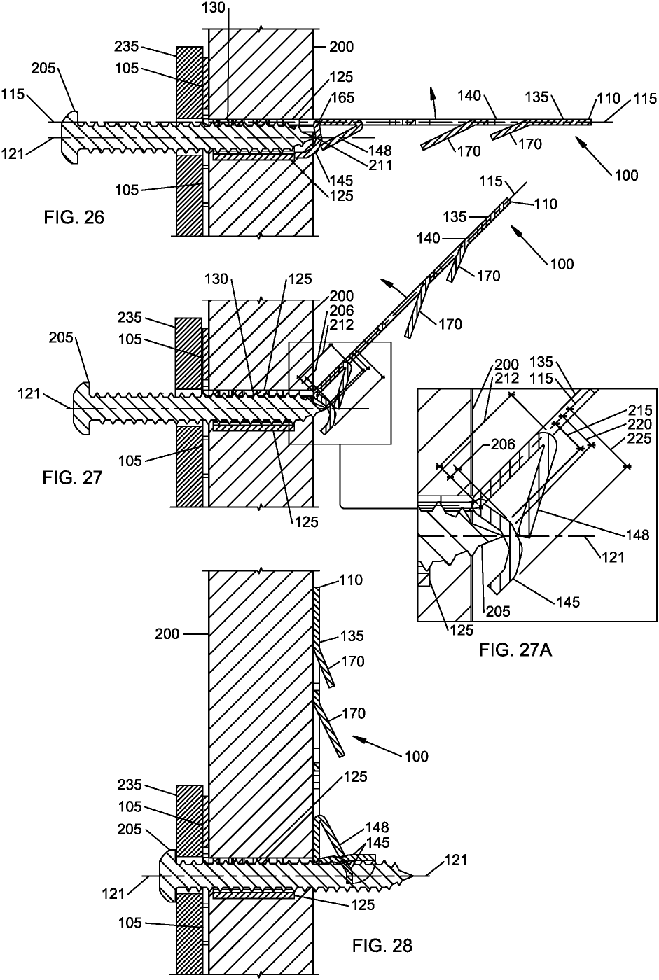

FIGS. 15-28 depict a second embodiment of anchor 100 that is substantially similar to the first embodiment of the anchor shown in FIGS. 1-14, with the primary exception being that the second projection 170 (between the distal-most projection 170 and the proximal-most projection 148) of the second embodiment is defined by a different opening 138 than that of projection 148. In particular, second projection 170 and projection 148 are formed such that a cross-brace 137 remains in the piece of sheet metal between the openings 138 defining the second projection 170 and projection 148.

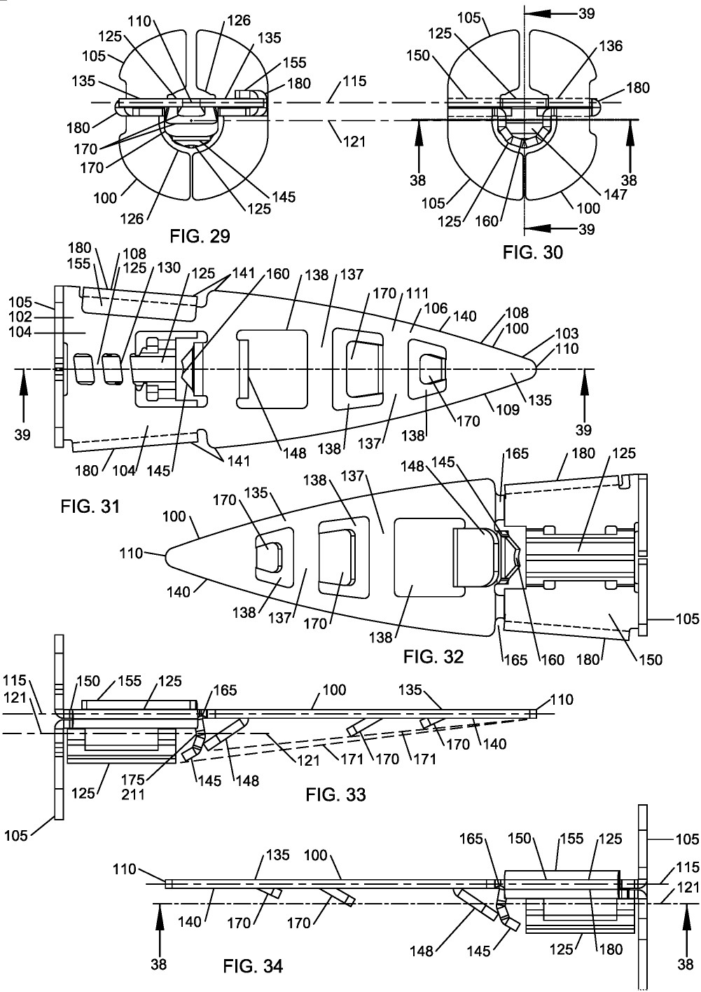

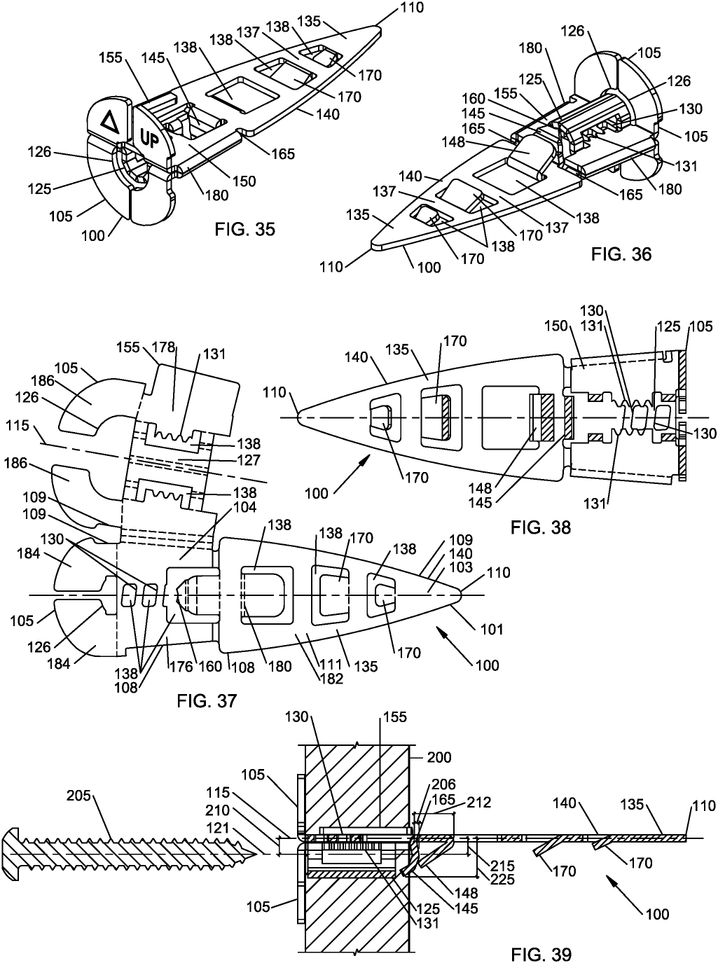

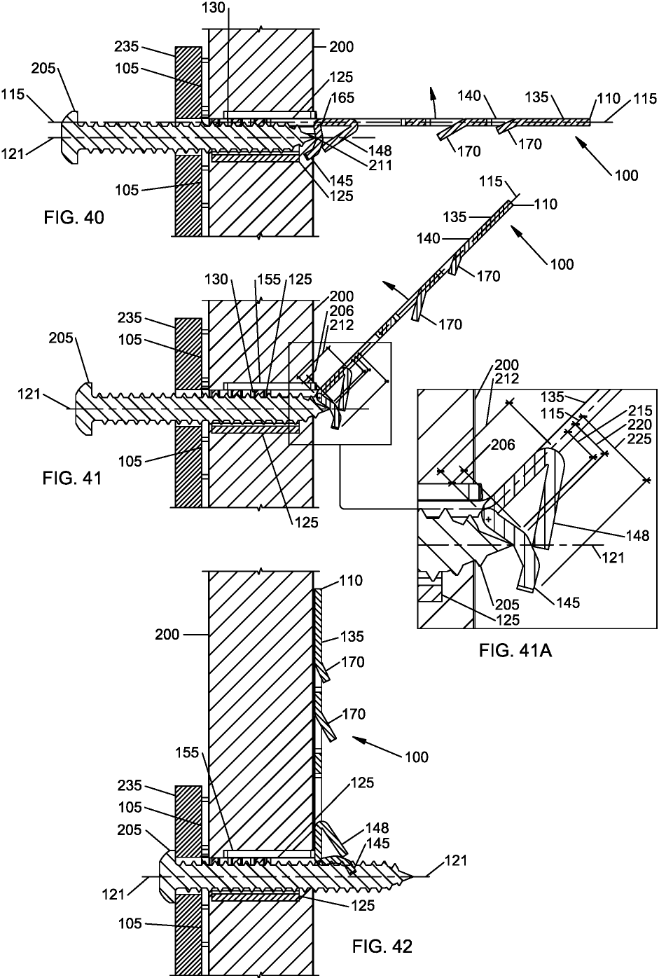

FIGS. 29-42 depict a third embodiment of anchor 100 that is substantially similar to the second embodiment of the anchor shown in FIGS. 15-28, with the primary exception that, in the third embodiment, section portion 178 of the piece of sheet metal is coupled to the first portion 176 of the piece of sheet metal via an edge portion 155 of the section portion of the piece of sheet metal that is bent around a corresponding edge of the first portion (176) to clamp the first and second portions 176, 178 together (and thereby resist separation of the second portion of the piece of sheet metal from the first portion of the piece of sheet metal along left edge 108 of the anchor). To allow the blade section (111) to bend more 90 degrees or more relative to axis 121, a distal end of edge portion 155 is spaced from the proximal end of the blade section—i.e., the distal end of edge portion 155 stops short of hinge sections 165 to that the edge portion 155 does not prevent the blade section from bending from 90 degrees to 110 degrees relative to axis 121. In addition, a notch 160 at the end of moment arm 145 provides a seat for the shaft of screw 205 which can slot between the threads of screw 205 to ensure engagement between the screw threads and the moment arm 145 to prevent slippage of moment arm 145 as the torque and applied forces are applied to blade section 111 to engage the distal side of substrate 200 to clamp anchor 100 to the substrate. In addition, on removal of screw 205 the curved seat 160 can be engaged by the screw threads to rotate or bend blade section 111 back away from the vertical plane (as shown) toward the original starting plane 115 of blade section 111, thereby facilitating removal of anchor 100 through the slot in substrate 200.

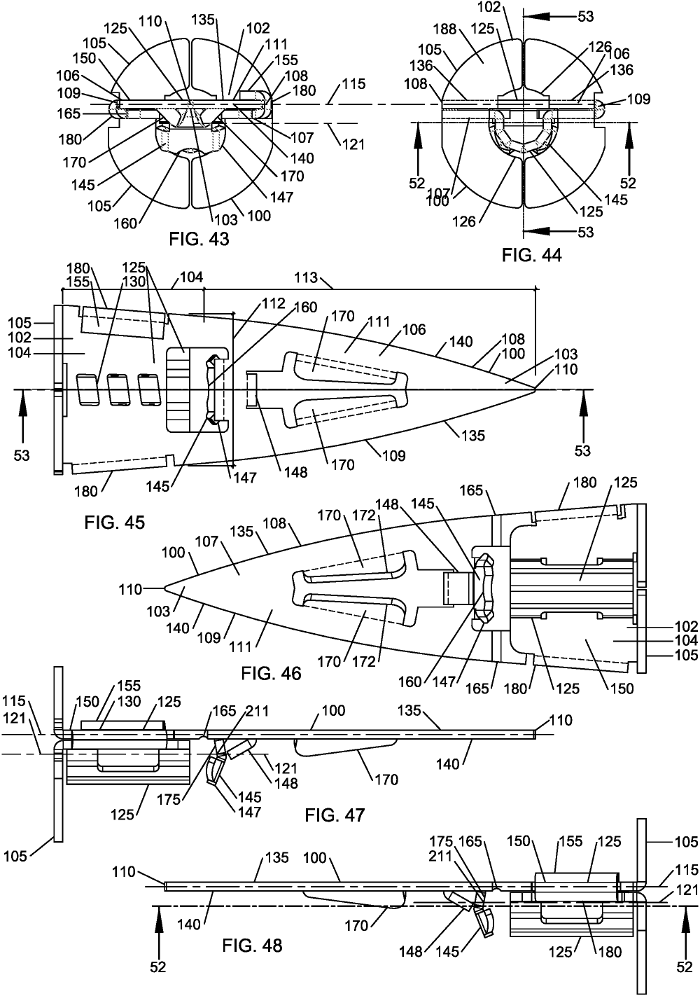

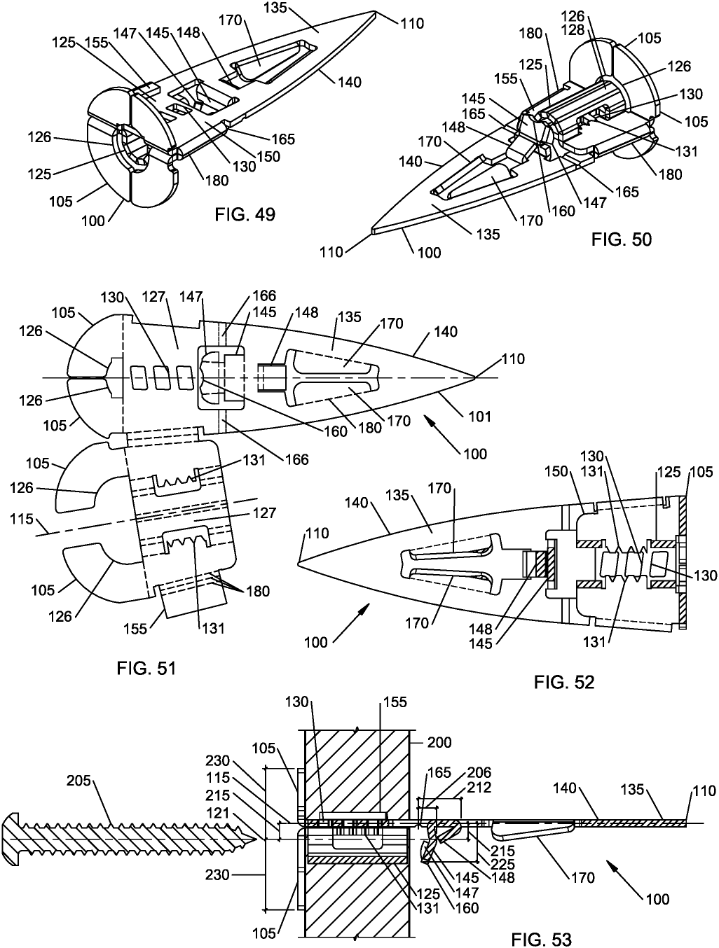

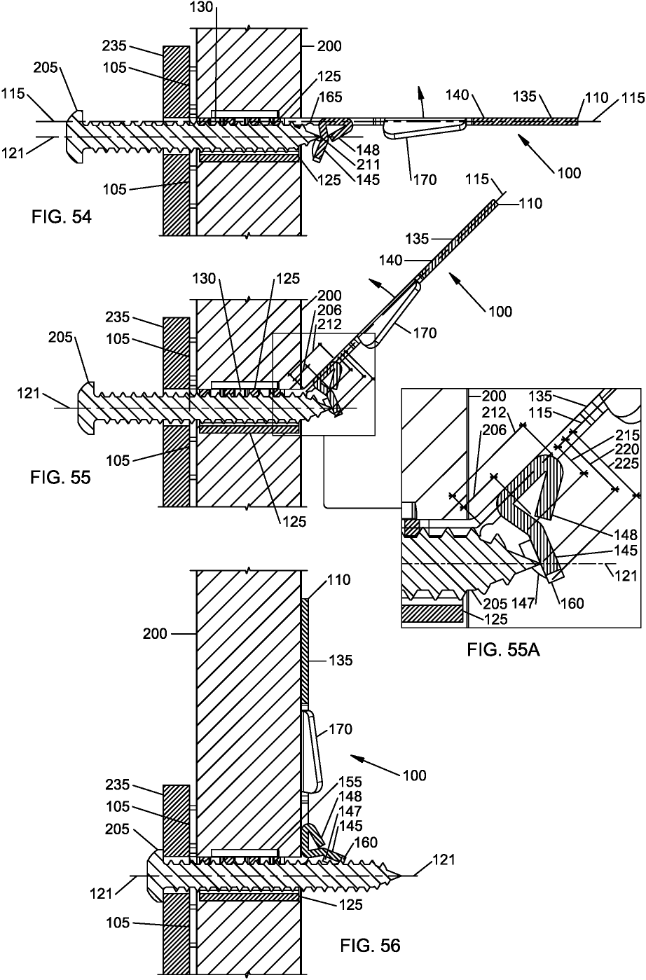

FIGS. 43-56 depict a fourth embodiment of anchor 100 that is substantially similar to the third embodiment of the anchor shown in FIGS. 29-42, with the primary exceptions that, in the fourth embodiment, (1) projections 170 are oriented longitudinally instead of laterally; and (2) moment arm 145 is bent such that cam surface 149 includes two linear segments, a first segment closest to plane 115 of the blade section and bent at less than 90 degrees relative to plane 115, and a second segment farther from plane 115 than the first segment and bent at more than 90 degrees relative to plane 115 toward the distal end of the anchor. In this fourth embodiment, projections 170 include two longitudinal projections with lower edges 172 that extend generally in the direction from distal end 103 toward proximal end 102. As with the projections 170 of the first three embodiments of FIGS. 1-42, projections 170 of the fourth embodiment of FIGS. 43-56 have a height that increases with distance from distal end 103 and works with projection of moment arm brace 148 and moment arm 145 to gradually separate and ease substrate material out of the substrate on the distal side as the anchor is pressed or driven through the substrate, and thereby form a channel to allow screw channel 125 to move through the substrate and create a clean entry for the base section of the anchor. Additionally, in this embodiment, the lower end of projection 148 is configured to contact the moment arm 145 at a vertical point (FIG. 54) through which axis 121 passes through the moment arm, such that projection 148 provides maximal support for moment arm at the point at which moment arm is first contacted and bent by the distal end of the screw (205).

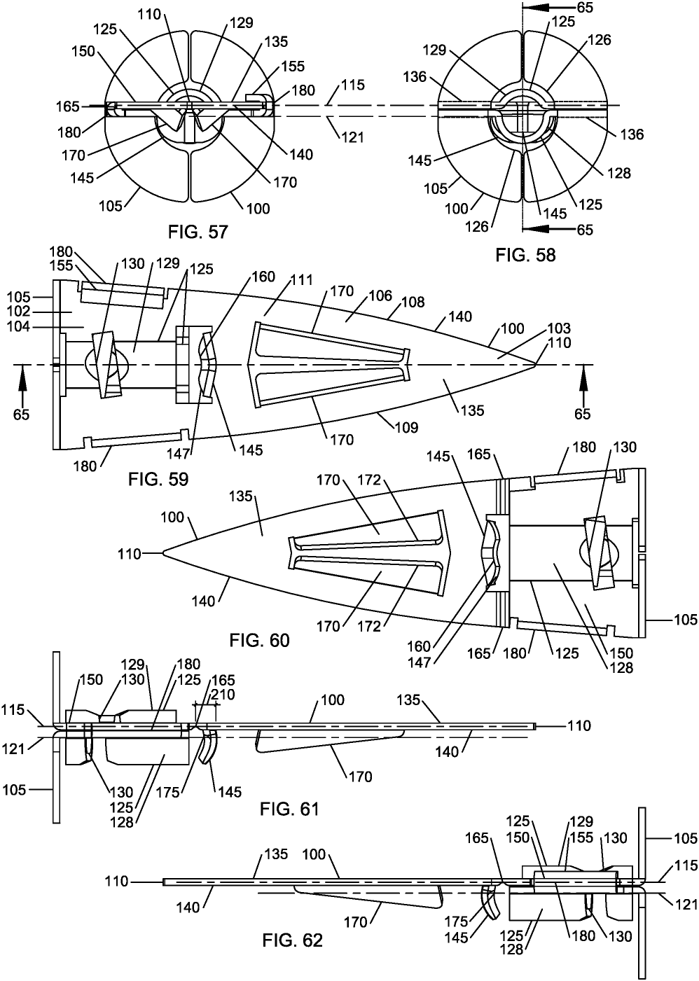

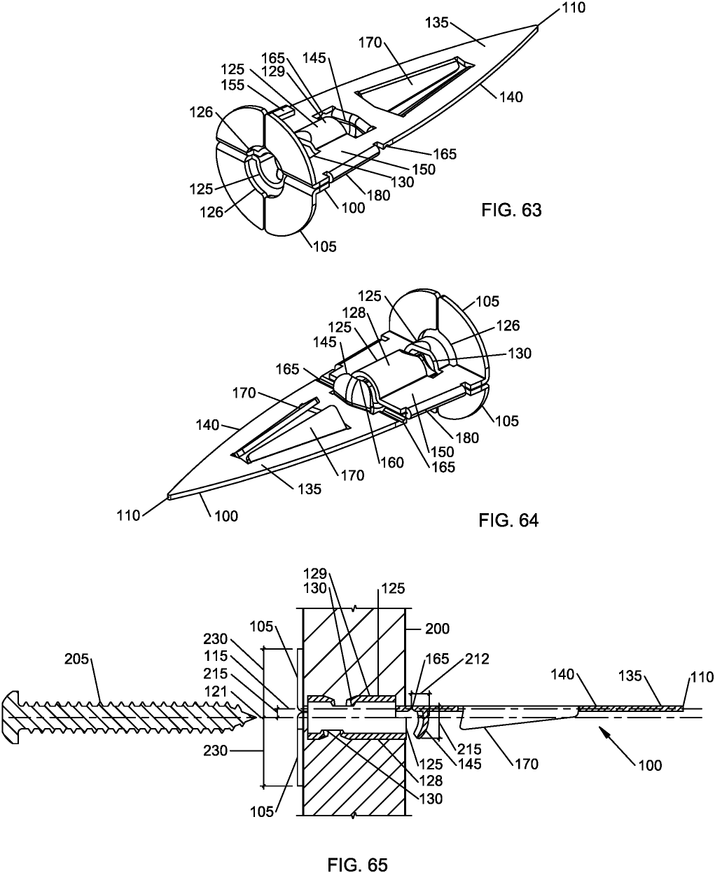

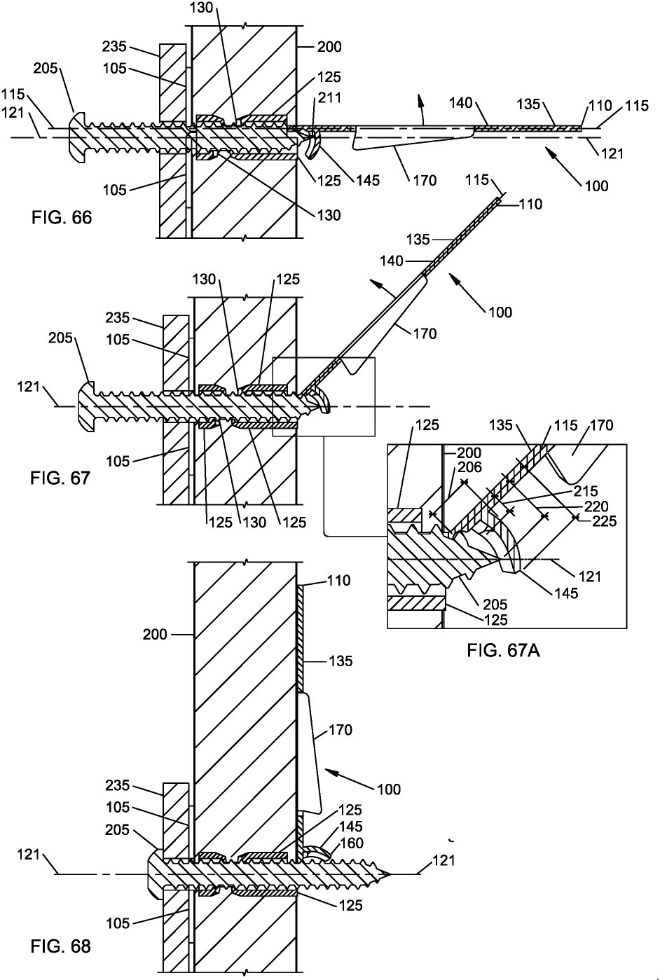

FIGS. 57-68 depict a fifth embodiment of anchor 100 that is substantially similar to the fourth embodiment of the anchor shown in FIGS. 43-56, with the primary exceptions that (1) blade section 111 of the fifth embodiment does not include a projection 148 that directly supports moment arm 145; the lower end of moment arm 145 does not extend proximally of hinge sections 165; (3) first portion 176 of the piece of sheet metal includes a second non-planar portion 129 that bends outward relative to second portion 178 of the piece of sheet metal, such that the first and second non-planar portions cooperate to define the screw channel 125; and (4) moment arm 145 is bent such that cam surface 149 includes a single arcuate segment. In this embodiment, the lack of projection 148 means that the moment arm may flex more than in those embodiments that include projection 148, such that moment arm 145 may either flex more or may be supported by tack welds between lateral wings or portions at the base of moment arm and adjacent, planar portions of the blade section. Additionally, the inclusion of second non-planar portion 129 means that first non-planar portion 128 need not extend as far from plane 115 (before blade section 111 is bent relative to base portion 104), meaning axis 121 is not offset as far in the vertical direction from plane 115 (before blade section 111 is bent relative to base portion 104, as in FIGS. 61-62). This results in a shorter initial moment arm distance 215 than in the first, second, third, and fourth embodiments of FIGS. 1-56, but the difference becomes proportionally less pronounced for moment arm distances 220 and 225 as blade section 111 bends relative to base section 104. The length of secondary moment arm distance 210 is increased from hinge 165, improving the leverage around hinge point 165 as the blade section bends away from parallel to axis 121, resulting in greater force and torque around hinge 165. Additionally, in this embodiment, first and second non-planar portions 128, 129 do not include notches or elongated openings to engage the threads of a screw, and instead include sub-projections 130 (FIG. 65) extending into screw channel 125 to engage the threads of the screw.

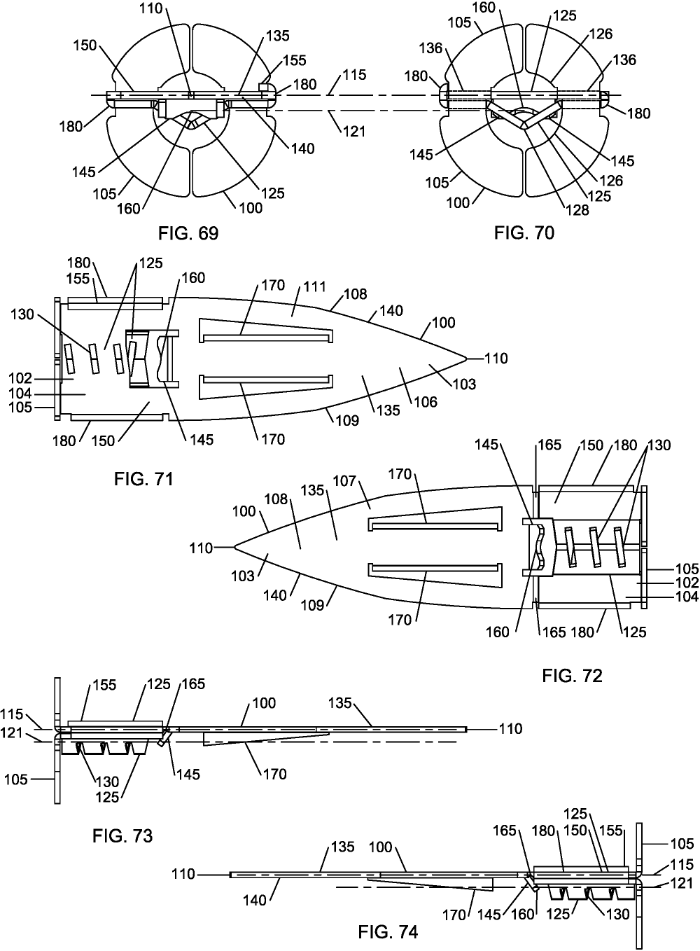

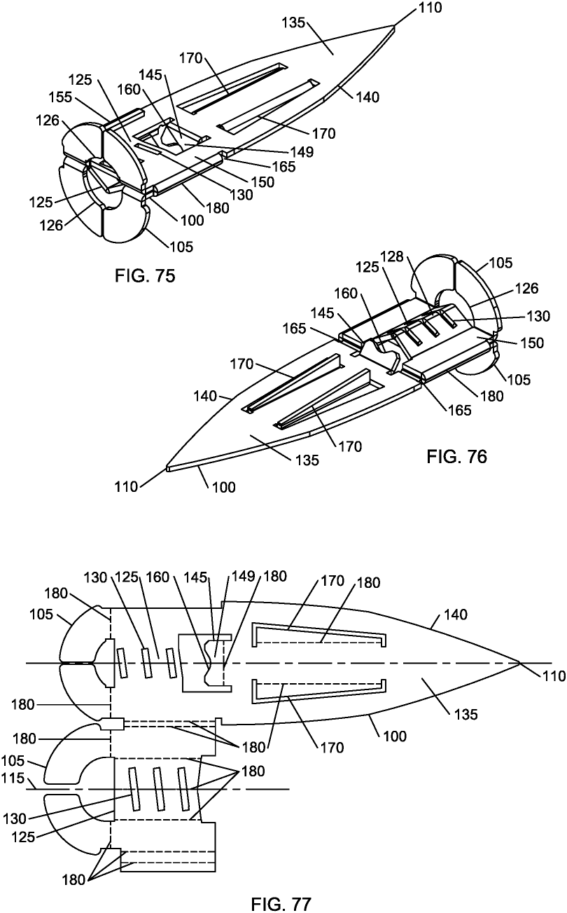

FIGS. 69-77 depict a sixth embodiment of anchor 100 that is substantially similar to the fourth embodiment of the anchor shown in FIGS. 43-56, with the primary exceptions that, in the sixth embodiment, (1) the second planar portion 178 of the piece of sheet metal includes elongated openings 130, similar to those in first planar portion 176, to engage the threads of a screw (205); (2) the bases of projections 170 are parallel to axis 121 such that projections 170 have a smaller height in the vertical direction (of FIGS. 73-74) than those of the fourth embodiment thereby greatly reducing the disruption to the substrate during installation; and (3) moment arm 145 is bent such that cam surface 149 includes a single linear segment. Additionally, in this sixth embodiment, a lower end of moment arm 145 includes a concave portion 160 to center the screw on the moment arm to ensure that the lower end of the moment arm tracks along the threads of the screw to continue to bend the moment arm once the distal end of the screw slips past the cam surface (149).

Some embodiments of the present kits comprise one or more of the present anchors, and a screw for each of the one or more anchors, where each screw is configured to be driven into the channel of a respective one of the anchors such that a distal end of the screw pushes the primary moment arm(s) toward the distal end of the anchor body and the torque created by the offset from blade section 115 to primary moment arm 121 applies the mechanical advantage from the primary moment arm(s) 210, 215, 225 to the secondary moment arm(s) 206 and 212 that causes the blade section to rotate or bend, at the transverse line of hinges 165, away from the longitudinal axis to an angle of from 5 degrees to 110 degrees relative to the longitudinal channel. Some such kits comprise a plurality of the present anchors, and at least one of the anchors differs in size relative to at least one other one of the plurality of anchors (e.g., with the anchors of differing size having screw channels (125) with different transverse dimensions (e.g., diameters), and/or base sections (104) of different lengths).

### Representative Embodiments

The following includes representative embodiments of the present clamping anchors, kits, and methods.

Embodiment 1. A clamping anchor comprising:
a body having a proximal end, a distal end, upper and lower sides extending from the proximal end to the distal end, and first and second edges extending from the distal end to the proximal end, the body including a blade section extending from the distal end toward the proximal end, a base section extending from the blade section toward the proximal end, and an enlarged head at the proximal end;
where the blade section has a width extending laterally between and to the left and right edges of the body along at least a majority of a length of the blade section, the width of the blade section increasing with distance from the distal end, the blade section comprising a moment arm projection on the lower side;
where the base section defines a screw channel that is configured to receive a screw along a longitudinal axis that is parallel to a plane of the blade section and offset from the blade section on the lower side such that the longitudinal axis extends through the moment arm projection; and
where the blade section is coupled to the base section along a transverse line that is substantially perpendicular to the longitudinal axis such that advancing a screw or pin through the screw channel and into the moment arm projection will cause the blade section to bend or rotate upward about the transverse line.

Embodiment 2. The anchor of Embodiment 1, where a proximal surface of the moment arm projection is offset longitudinally from the transverse line toward the distal end of the blade section.

Embodiment 3. The anchor of Embodiment 1, where the blade section further comprising one or more pilot projections extending from a planar portion of the blade section on the lower side by a height that increases with distance from the distal end.

Embodiment 4. The anchor of Embodiment 3, where the one or more pilot projections comprises a plurality of pilot projections, and at least one of the pilot projections is configured to resist deflection of the moment arm projection toward the distal end.

Embodiment 5. The anchor of Embodiment 4, where the at least one of the pilot projections contacts the moment arm projection and is configured to direct a force received at the moment arm projection to the blade section to urge the blade section upward as the blade bends or rotates.

Embodiment 6. The anchor of Embodiment 4, where the pilot projection configured to resist deflection of the moment arm projection has a lower end that is configured to contact the moment arm projection at a vertical point through which the longitudinal axis passes.

Embodiment 7. The anchor of any of Embodiments 4-6, where the plurality of pilot projections are spaced along a length of the blade section, each of the pilot projections has a vertical dimension, and the vertical dimensions of the pilot projections increase with distance from the distal end.

Embodiment 8. The anchor of any of Embodiments 1-7, where the moment arm projection is longitudinally curved or bent to define a concave cam surface that faces the proximal end.

Embodiment 9. The anchor of Embodiment 8, where the moment arm projection is configured such that, as the blade section rotates upward, a distal end of the screw or pin contacts the moment arm projection at a contact point, and the distance between the contact point and the transverse line increases.

Embodiment 10. The anchor of any of Embodiments 8-9, where a first portion of the cam surface intersected by the longitudinal axis is disposed at an angle of between 5 and 90 degrees relative to the longitudinal axis.

Embodiment 11. The anchor of Embodiment 10, where a second portion of the cam surface is disposed at an angle of between 90 degrees and 120 degrees relative to the longitudinal axis.

Embodiment 12. The anchor of Embodiment 11, where the moment arm projection is configured such that, as the blade section rotates upward, the contact point moves from the first portion of the cam surface to the second portion of the cam surface.

Embodiment 13. The anchor of Embodiment 11, where a third portion of the cam surface is disposed at an angle of between 120 and 145 degrees relative to the longitudinal axis.

Embodiment 14. The anchor of Embodiment 13, where the moment arm projection is configured such that, as the blade section rotates upward, the contact point moves from the second portion of the cam surface to the third portion of the cam surface.

Embodiment 15. The anchor of Embodiment 13, where a fourth portion of the cam surface is disposed at an angle of from 145 to 180 degrees relative to the longitudinal axis.

Embodiment 16. The anchor of Embodiment 15, where the moment arm projection is configured such that, as the blade section rotates upward, the contact point moves from the third portion of the cam surface to the fourth portion of the cam surface.

Embodiment 17. The anchor of any of Embodiments 1-16, where the moment arm is laterally curved or bent to define a screw path extending along at least a portion of a length of the moment arm to center a screw received through the screw channel to contact the moment arm.

Embodiment 18. The anchor of Embodiment 8, where a lower end of the moment arm extends longitudinally under the base section.

Embodiment 19. The anchor of any of Embodiments 1-18, where the blade section has a first thickness measured in a vertical direction that is substantially perpendicular to each of the longitudinal axis and the transverse line, and the body has a second thickness along that transverse line, the second thickness measured in the vertical direction and being less than the first thickness.

Embodiment 20. The anchor of any of Embodiments 1-19, where the body is configured such that driving a screw or pin through the channel and into the moment arm will push a portion of the moment arm toward the distal end and cause the blade section to bend or rotate, at the transverse line, away from the longitudinal axis.

Embodiment 21. The anchor of Embodiment 20, where the blade section is configured to bend to an angle of from 5 degrees to 110 degrees relative to the longitudinal axis.

Embodiment 22. The anchor of any of Embodiments 1-21, where the body is defined by a single piece of sheet metal.

Embodiment 23. The anchor of Embodiment 22, where the base section is defined by a first portion of the piece of sheet metal, and a second portion of the piece of sheet metal, where the second portion of the piece of sheet metal is bent along the first edge relative to the first portion of the piece of sheet metal, and the second portion of the piece of sheet metal is coupled adjacent the second edge to the first portion of the piece of sheet metal, such that the second portion of the piece of sheet metal defines the lower side of the base section, the first portion of the piece of sheet metal defines the upper side of the base section, and the channel is defined between the first and second portions of the piece of sheet metal.

Embodiment 24. The anchor of Embodiment 23, where the second portion of the piece of sheet metal is bent around a lateral edge of the first portion of the piece of sheet metal along the second edge of the body to resist separation of the second portion of the piece of sheet metal from the first portion of the piece of sheet metal along the second edge.

Embodiment 25. The anchor of any of Embodiments 23-24, where the first portion of the piece of sheet metal includes a first non-planar portion that bends outward relative to the second portion of the piece of sheet metal, and the second portion of the piece of sheet metal includes a second non-planar portion that bends outward relative to the first portion of the piece of sheet metal, such that the first and second non-planar portions cooperate to define the channel.

Embodiment 26. The anchor of any of Embodiments 23-25, where the first portion of the piece of sheet metal includes at least one first opening configured to receive a portion of a thread of a screw driven into the channel.

Embodiment 27. The anchor of any of Embodiments 23-26, where the second portion of the piece of sheet metal includes at least one second opening configured to receive a portion of a thread of a screw driven into the channel.

Embodiment 28. The anchor of Embodiment 27, where the second portion of the piece of sheet metal includes one or more projections extending into the channel and shaped to engage a portion of a thread of a screw driven into the channel.

Embodiment 29. The anchor of any of Embodiments 23-28, where blade section is defined by a third portion of the piece of sheet metal that includes a substantially planar blade region, and the first portion of the piece of sheet metal includes a substantially planar base region that is coplanar with the substantially planar blade region.

Embodiment 30. The anchor of any of Embodiments 23-29, where the enlarged head is defined by fourth and fifth portions of the piece of sheet metal that are substantially perpendicular to the longitudinal axis, where the fourth portion of the piece of sheet metal extends from the first portion of the piece of sheet metal, and the fifth portion of the piece of sheet metal extends from the second portion of the piece of sheet metal.

Embodiment 31. The anchor of Embodiment 30, where a distal surface of the enlarged head includes indicia indicating the direction of the upper side and/or the direction of the lower side.

Embodiment 32. The anchor of any of Embodiments 1-31, where a distance between the transverse line and a distal surface of the enlarged head is between 0.2 inches and 0.8 inches (or between 0.4 inches and 1.6 inches).

Embodiment 33. The anchor of Embodiment 32, where a distance between the transverse line and a distal surface of the enlarged head is between 0.2 inches and 0.3 inches.

Embodiment 34. The anchor of Embodiment 32, where a distance between the transverse line and a distal surface of the enlarged head is between 0.35 inches and 0.4 inches.

Embodiment 35. The anchor of Embodiment 32, where a distance between the transverse line and a distal surface of the enlarged head is between 0.4 inches and 0.6 inches (or between 0.8 inches and 1.2 inches).

Embodiment 36. The anchor of Embodiment 32, where a distance between the transverse line and a distal surface of the enlarged head is between 0.6 inches and 0.65 inches (or between 1.2 inches and 1.3 inches).

Embodiment 37. The anchor of Embodiment 32, where a distance between the transverse line and a distal surface of the enlarged head is between 0.7 and 0.8 inches (or between 1.4 inches and 1.6 inches).

Embodiment 38. A kit comprising:
one or more anchors of any of Embodiments 1-37; and
a screw for each of the one or more anchors, where each screw is configured to be driven into the channel of a respective one of the anchors such that a distal end of the screw pushes the moment arm toward the distal end of the anchor body and causes the blade section to bend, at the transverse line, away from the longitudinal axis to an angle of from 5 degrees to 110 degrees relative to the longitudinal channel.

Embodiment 39. The kit of Embodiment 38, where the one or more anchors comprises a plurality of anchors.

Embodiment 40. The kit of Embodiment 39, where at least one of the plurality of anchors differs in size relative to at least one other one of the plurality of anchors.

Embodiment 41. The kit of Embodiment 40, where the anchors of differing size have channels with different transverse dimensions.

Embodiment 42. The kit of any of Embodiments 40-41, where the anchors of differing sizes have base sections of different lengths.

Embodiment 43. A method comprising:
inserting an anchor of any of Embodiments 1-36 through a substrate; and
driving a screw or nail through the channel such that a distal end of the screw or nail pushes the moment arm toward the distal end of the anchor body and causes the blade section to bend, at the transverse line, away from the longitudinal axis.

Embodiment 44. The method of Embodiment 43, where the substrate or wallboard comprises drywall.

Embodiment 45. The method of any of Embodiments 43-44, where the anchor is inserted through the substrate or wallboard without first drilling a pilot hole in the substrate or wallboard.

Embodiment 46. The method of any of Embodiments 43-45, where the screw or pin is driven through the channel to a point at which the blade section is bent away from the longitudinal axis at an angle of from 5 degrees to 110 degrees relative to the longitudinal axis.

Embodiment 47. The method of claim 46, where the screw or nail is driven through the channel to a point at which the blade section is bent away from the longitudinal axis at an angle of at least 75 degrees relative to the longitudinal axis.

### Reference Numerals

The following reference numerals generally designate various listed components in the figures:
100 Anchor
101 Anchor unfolded
102 Proximal end
103 Distal end
104 Base section
105 Head
106 Upper side
107 Lower side
108 Left edge
109 Right edge
110 Tip
111 Blade section
112 Blade width
113 Blade length
115 Centerline plane of blade
120 Centerline of anchor head
121 Centerline of Screw
125 Screw or Pin channel
126 Countersink / Opening in head for screw
127 Screw or pin channel (125) shown flat
128 First non-planar portion defining the screw or pin channel (125)
129 Second non-planar portion defining the screw or pin channel (125)
130 Screw thread engagement channels
131 Notches to engage screw threads
135 Flat blade
136 Flat blade (hidden in view)
137 Cross brace
138 Opening
140 Tapered edge
141 Blade Extends beyond width of main anchor body
145 Moment/Lever arm or CAM
145a First moment/lever arm or CAM segment (e.g., 5-90 degrees)
145b Second moment/lever arm or CAM segment (e.g., 90 - 120 degrees)
145c Third moment/lever arm or CAM segment (e.g., 120 - 145 degrees)
145d Fourth moment/lever arm or CAM segment (e.g., 145 - 180 degrees)
146 Extended lever arm engages screw
147 Angled or cupped edge of lever arm or cam
148 Brace support for lever arm or CAM
149 Cam surface
150 Double thick flat load bearing area
155 Fold over locking strap
156 Swag, Rivet, Weld, Dimple, Punch or other suitable Binding
160 Shaped centering seat for screw or pin
165 Hinge Section - Tapered
166 Hinge Section - Flat Profile
170 Tapered sloped wedge
171 Gentle tapered slope from tip to lever arm, CAM and screw barrel
172 Lower edges of projections 170
175 Slope or curve at base of lever arm or CAM
176 First portion of piece of sheet metal
178 Second portion of piece of sheet metal
180 Fold
182 Third portion of piece of sheet metal
184 Fourth portion of piece of sheet metal
186 Fifth portion of piece of sheet metal
188 Indicia indicating desired orientation of anchor
200 Wall, ceiling, or substrate material
205 Screw or Activation Pin
206 Offset from hinge sections 165 to intersection of screw axis 121 and initial position of moment arm 145
210 Offset from hinge sections 165 to intersection of screw axis 121 and initial position of moment arm 145
211 Initial point of contact of screw or pin on lever arm or cam
212 Secondary Moment Arm Extended Distance
215 Primary Moment Arm Distance (Initial Engagement Length)
220 Primary Moment Arm Distance (45 Degree Rotation Engagement Length)
225 Primary Moment Arm Distance (90 Degree Rotation Engagement Length)
230 Equal
235 Fixture

The above specification and examples provide a complete description of the structure and use of exemplary embodiments. Although certain embodiments have been described above with a certain degree of particularity, or with reference to one or more individual embodiments, or substrates, those skilled in the art could make numerous alterations to the disclosed embodiments without departing from the scope of this invention. As such, the various illustrative embodiments of the present devices are not intended to be limited to the particular forms, materials or substrates disclosed. Rather, they include all modifications and alternatives falling within the scope of the claims, and embodiments other than the one shown may include some or all of the features of the depicted embodiment. For example, components may be combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A clamping anchor comprising:
a body having a proximal end, a distal end, upper and lower sides extending from the proximal end to the distal end, and first and second edges extending from the distal end to the proximal end, the body including a blade section extending from the distal end toward the proximal end, a base section extending from the blade section toward the proximal end, and an enlarged head at the proximal end;
where the blade section has a width extending laterally between and to the left and right edges of the body along at least a majority of a length of the blade section, the width of the blade section increasing with distance from the distal end, the blade section comprising a moment arm projection on the lower side;
where the base section defines a screw channel that is configured to receive a screw along a longitudinal axis that is parallel to a plane of the blade section and offset from the blade section on the lower side such that the longitudinal axis extends through the moment arm projection; and
where the blade section is coupled to the base section along a transverse line that is substantially perpendicular to the longitudinal axis such that advancing a screw or nail through the screw channel and into the moment arm projection will cause the blade section to bend or rotate upward about the transverse line.

2. The anchor of claim 1, where a proximal surface of the moment arm projection is offset longitudinally from the transverse line toward the distal end of the blade section.

3. The anchor of claim 1, where the blade section further comprising a plurality of pilot projections, at least one of the pilot projections is configured to contact the moment arm projection and to direct a force received at the moment arm projection to the blade section to urge the blade section upward as the blade bends or rotates.

4. The anchor of claim 3, where the plurality of pilot projections are spaced along a length of the blade section, each of the pilot projections has a vertical dimension, and the vertical dimensions of the pilot projections increase with distance from the distal end.

5. The anchor of claim 1, where the moment arm projection is longitudinally curved or bent to define a concave cam surface that faces the proximal end.

6. The anchor of claim 5, where the moment arm projection is configured such that, as the blade section rotates upward, a distal end of the screw or pin contacts the moment arm projection at a contact point, and the distance between the contact point and the transverse line increases.

7. The anchor of claim 6, where a first portion of the cam surface intersected by the longitudinal axis is disposed at an angle of between 5 and 90 degrees relative to the longitudinal axis.

8. The anchor of claim 7, where a second portion of the cam surface is disposed at an angle of between 90 degrees and 120 degrees relative to the longitudinal axis.

9. The anchor of claim 8, where the moment arm projection is configured such that, as the blade section rotates upward, the contact point moves from the first portion of the cam surface to the second portion of the cam surface.

10. The anchor of claim 1, where the moment arm is laterally curved or bent to define a screw path extending along at least a portion of a length of the moment arm to center a screw received through the screw channel to contact the moment arm.

11. The anchor of claim 5, where a lower end of the moment arm extends longitudinally under the base section.

12. The anchor of claim 1, where the body is configured such that driving a screw or pin through the channel and into the moment arm will push a portion of the moment arm toward the distal end and cause the blade section to bend or rotate, at the transverse line, away from the longitudinal axis, and the blade section is configured to bend to an angle of from 5 degrees to 110 degrees relative to the longitudinal axis.

13. The anchor of claim 1, where the body is defined by a single piece of sheet metal.

14. The anchor of claim 1, where a distance between the transverse line and a distal surface of the enlarged head is between 0.2 inches and 0.8 inches.

15. A kit comprising:
one or more anchors of claim 1; and
a screw for each of the one or more anchors, where each screw is configured to be driven into the channel of a respective one of the anchors such that a distal end of the screw pushes the moment arm toward the distal end of the anchor body and causes the blade section to bend, at the transverse line, away from the longitudinal axis to an angle of from 5 degrees to 110 degrees relative to the longitudinal channel.

16. The kit of claim 15, where the one or more anchors comprises a plurality of anchors.

17. The kit of claim 16, where at least one of the plurality of anchors differs in size relative to at least one other one of the plurality of anchors.

18. A method comprising:
inserting an anchor of claim 1 through a substrate; and
driving a screw or pin through the channel such that a distal end of the screw or pin pushes the moment arm toward the distal end of the anchor body and causes the blade section to bend, at the transverse line, away from the longitudinal axis.

19. The method of claim 18, where the substrate or wallboard comprises drywall.

20. The method of claim 19, where the anchor is inserted through the substrate or wallboard without first drilling a pilot hole in the substrate or wallboard.
